(19) United States
(12) Patent Application Publication
(10) Pub. No.: US 2021/0049910 A1
(43) Pub. Date: Feb. 18, 2021

(54) USING HOLISTIC DATA TO IMPLEMENT ROAD SAFETY MEASURES

(71) Applicant: Ford Global Technologies, LLC, Dearborn, MI (US)

(72) Inventors: Jonathan Wood, Livonia, MI (US); Bo Wang, Northville, MI (US); Callahan Coplai, Detroit, MI (US); Wesley Powell, Ann Arbor, MI (US)

(73) Assignee: Ford Global Technologies, LLC, Dearborn, MI (US)

(21) Appl. No.: 16/539,804

(22) Filed: Aug. 13, 2019

(51) Int. Cl. G08G 1/16; G08G 1/01

(52) U.S. Cl. CPC G08G 1/164; G08G 1/012; G08G 1/0141; G08G 1/163; G08G 1/0116; G08G 1/0129

(57) ABSTRACT

Exemplary embodiments described in this disclosure are generally directed to using holistic data for implementing road safety measures. In an exemplary method, a computer receives data from various sources and analyzes the data for rendering a graphic that may be used to identify road locations susceptible to traffic accidents. The various sources of data can include a vehicle that provides connected vehicle data and/or sensor data. Other sources of data may include social media data, Internet-of-Things (IoT) data, and road infrastructure data. The social media data can include content posted online about events or conditions that are indicative of risk factors for users of certain roads. The road infrastructure data may provide information pertaining to structures that contribute to risk factors for users of certain roads.

### FIELD OF THE DISCLOSURE

This disclosure generally relates to road safety and more particularly relates to systems and methods for analyzing various types of data in a holistic manner for implementing road safety measures.

### BACKGROUND

Many road safety measures have been traditionally implemented by using information gained from police reports (crash reports, traffic accident reports, fatality statistics, injury statistics, etc.). However, some of the information gained from police reports may be outdated and/or irrelevant. Consequently, at least some road safety measures that are implemented based on this type of information may prove to be inadequate and/or late.

Some traditional implementations may also not take into consideration certain types of data that are not included in police reports but have an impact on road safety. For example, people involved in minor traffic accidents may decide against reporting such accidents to the police due to various reasons such as inconvenience, time delays, and insurance hassles. Such information is consequently not present in police reports. Some people who are aware, or become aware, of certain situations or events that may pose a hazard to road users may also fail to report such situations or events to the police and/or roadway owners for various reasons. For example, residents of a certain neighborhood may be aware of drivers driving at high speed through the neighborhood at certain times of the day but may presume that this behavior is not something to be reported to the police unless an accident were to occur. Consequently, no measures may be taken to address this unreported issue even though it would be desirable to obtain information about such situations and use the information to implement road safety measures.

In some cases, road safety measures that are implemented to address certain types of issues may lead to unexpected and undesirable consequences. For example, erecting traffic lights at a certain intersection may result in drivers choosing an alternative route in order to avoid waiting at the traffic light. As a result, the alternative route may experience unexpected traffic congestion and new traffic hazards may be created.

It is therefore desirable to provide solutions that address such shortcomings in traditional methods for implementing road safety measures.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an exemplary system for implementing road safety measures based on holistic data obtained from various sources in accordance with the disclosure.

FIG. 2 shows some exemplary components that may be included in some of the elements of the system shown in FIG. 1.

FIG. 3 shows an exemplary representation of various sources of data that may be used to implement road safety measures in accordance with the disclosure.

FIG. 4 shows an exemplary flowchart of a method for using holistic data to implement road safety measures in accordance with the disclosure.

FIG. 5 shows an exemplary graphical representation that may be provided based on information gained by analyzing holistic data in accordance with the disclosure.

### DETAILED DESCRIPTION

### Overview

In terms of a general overview, certain embodiments described in this disclosure are directed to systems and methods related to using holistic data for implementing road safety measures. In an exemplary method in accordance with the disclosure, a computer receives data from various sources and analyzes the data in a holistic manner for rendering a graphic or displaying an image that may be used to identify locations on a road that are susceptible to traffic accidents. The various sources of data may include connected vehicle data obtained by an onboard computer of a vehicle and/or sensor data obtained by one or more sensors provided in the vehicle. Other sources of data may include social media data, Internet-of-Things (IoT) data, and road infrastructure data. The social media data can include content posted online about events or conditions that are indicative of risk factors for users of certain roads. The road infrastructure data may provide information pertaining to objects that contribute to risk factors for users of certain roads.

### Illustrative Embodiments

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the phrase “server computer” as used in this disclosure refers to one or more of various types of computers that may be located in various places for carrying out various kinds of data processing functions. The word “dataset” as used in this disclosure can refer to any of various types of data such as structured data, unstructured data, ordered data, random data, static data, dynamic data, numbers, text, alphanumeric characters, graphs, maps, and images. The word “road” as used in this disclosure encompasses various types of surfaces on which a motorized vehicle or a non-motorized vehicle can travel. A singular use of the word “road” encompasses plural instances (roads, streets, highways, etc.). Words such as “wireless” or “wirelessly” as used herein are not intended to preclude other forms of communication such as optical communications and wired communications. The examples provided herein encompass such alternative communication technologies. Furthermore, it should be understood that the word “example” as used herein is intended to be non-exclusionary and non-limiting in nature. More particularly, the word “exemplary” as used herein indicates one among several examples, and it should be understood that no undue emphasis or preference is being directed to the particular example being described. The exemplary embodiments described below refer to an autonomous vehicle 105 and an autonomous vehicle 110. However, it must be understood that the description and scope of the disclosure is not limited to autonomous vehicles and encompasses a wide variety of vehicles such as, for example, connected vehicles and non-motorized vehicles. A connected vehicle may include equipment that carries out machine-to-machine communications with equipment provided in other connected vehicles. That is, in some instances, one or more (or all) of the vehicles may include human operators.

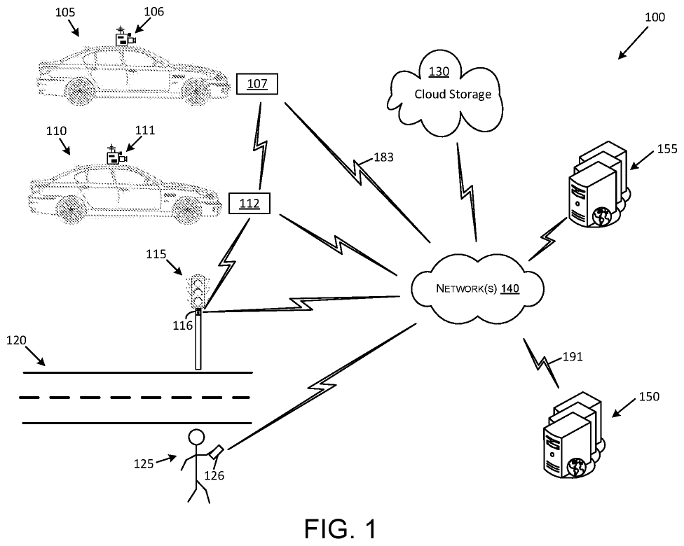

FIG. 1 shows an exemplary system 100 for implementing road safety measures based on holistic data obtained from various sources in accordance with the disclosure. The exemplary system 100 may include a server computer 150 that is communicatively coupled to a network 140 using one or more types of communications links and communication protocols. In one exemplary implementation, the server computer 150 may be communicatively coupled to the network 140 by a wireless communications link 191. In another exemplary implementation, the server computer 150 may be communicatively coupled to the network 140 by using transmission media such as coaxial cables, wires, and fiber optic cables.

The server computer 150 can use the network 140 to communicate with various elements such as an onboard computer 107 that is provided in an autonomous vehicle 105, an onboard computer 112 that is provided in another autonomous vehicle 110, an Internet-of-Things (IoT) module 116 mounted on a traffic light 115, a personal device 126 carried by a pedestrian 125, a social media computer 155, and cloud storage 130.

The network 140 may include any one or combination of networks, such as a local area network (LAN), a wide area network (WAN), a telephone network, a cellular network, a cable network, a wireless network, and/or private/public networks such as the Internet. In some instances, the network 140 may support communication technologies such as Bluetooth, cellular, near-field communication (NFC), Wi-Fi, Wi-Fi direct, machine-to-machine communication, and/or man-to-machine communication.

The autonomous vehicle 105 and the autonomous vehicle 110 are merely two exemplary vehicles that may travel on an exemplary road 120. Various portions of the description provided below with respect to the autonomous vehicle 105 may be equally applicable to the autonomous vehicle 110 as well as various other types of vehicles, and should be understood as such. For example, various features and operations of components provided in the autonomous vehicle 105 and described below (such as the onboard computer 107, and a navigation assistance equipment 106, etc.) can be identical or substantially similar to various features and operations of components provided in the autonomous vehicle 110 (such as the onboard computer 112, a navigation assistance equipment 111, etc.).

The navigation assistance equipment 106 provided in the autonomous vehicle 105 can be used by the onboard computer 107 to execute and control various operations of the autonomous vehicle 105. Operations may include detecting and avoiding objects and pedestrians while driving on the road 120, navigating from a designated starting point to a designated destination, and assisting passengers in some ways. The navigation assistance equipment 106 may be mounted on the roof of the autonomous vehicle 105 and can include various components such as transponders, sensors, video recorders, audio recorders, and imaging devices. A few exemplary sensors that may be a part of the navigation assistance equipment 106 are motion detectors, distance sensors, proximity sensors, and audio sensors. A few exemplary imaging devices that may be a part of the navigation assistance equipment 106 include a digital camera configured to capture digital images or a video camera configured to capture video footage.

The onboard computer 107 can be used to not only execute and control various operations of the autonomous vehicle 105 but can also include a communications system (not shown) that allows the onboard computer 107 to communicate with various devices such as the onboard computer 112 of the autonomous vehicle 110, the server computer 150, the IoT module 116 mounted on the traffic light 115, the personal device 126 carried by the pedestrian 125, the social media computer 155, and one or more data storage components of the cloud storage 130. Communications between the onboard computer 107 and the server computer 150 may be carried out through the network 140 by using various types of communications links and communication protocols. In one exemplary implementation, the onboard computer 107 may be communicatively coupled to the network 140 by a wireless communications link 183 and a machine-to-machine (M2M) communication protocol may be used for transmitting information between the onboard computer 107 and the server computer 150.

The onboard computer 107 may also use the communications system to communicate with various other elements without using the network 140. For example, the onboard computer 107 may use a Wi-Fi transmission protocol that does not propagate through the network 140, to wirelessly communicate with the onboard computer 112 of the autonomous vehicle 110, the IoT module 116 mounted on the traffic light 115, and/or the personal device 126 carried by the pedestrian 125. Such types of wireless communications can support collection and use of what is known in the industry as “connected vehicle data.”

In an exemplary application, the onboard computer 107 can obtain various types of data from transponders, sensors, imaging devices, etc. of the navigation assistance equipment 106 and transfer the data (in real-time or after a time delay) to various devices such as the server computer 150, the onboard computer 112, and cloud storage 130. In some cases, the data obtained by the onboard computer 107 from the navigation assistance equipment 106 may be temporarily stored in an on-board data storage system of the autonomous vehicle 105 and used at a later time, such as, for example, when the autonomous vehicle 105 returns to a garage at night.

A few non-exhaustive examples of the types of data obtained by the onboard computer 107 from one or more components of the navigation assistance equipment 106 can include data pertaining to a situation where the autonomous vehicle 105 took evasive action to avoid colliding with the pedestrian 125 (data such as, for example, a location of the pedestrian 125, direction in which the pedestrian 125 was walking, distance at which the pedestrian 125 was detected, etc.), data pertaining to a situation where the autonomous vehicle 105 encountered a near-miss with another vehicle (data such as, for example, a location of the near-miss, a direction in which the other vehicle was traveling, a speed at which the other vehicle was traveling, etc.), data pertaining to a situation where the autonomous vehicle 105 had to slow down (data such as, for example, bad weather, bad road surface condition, etc.), and/or data pertaining to a situation where the autonomous vehicle 105 took an alternative route or was diverted due to a traffic situation (data such as, for example, a traffic accident, a large crowd, police activity, etc.).

The IoT module 116, which is mounted on the traffic light 115 (or on a roadside fixture such as a building, a pole, or an enclosure), may be configured to gather various types of data for sharing with the server computer 150, the onboard computer 107 of the autonomous vehicle 105, and/or the onboard computer 112 of the autonomous vehicle 110. The IoT module 116 can include devices such as motion detectors, audio detectors, imaging devices, and recording devices that detect various types of activities taking place in the vicinity of the traffic light 115. For example, the IoT module 116 may include an imaging device that is used for capturing images and/or videos of various activities such as pedestrians standing on a sidewalk beside the road 120, pedestrians crossing the road 120 at a pedestrian crosswalk, pedestrians crossing the road 120 at places other than a pedestrian crosswalk, vehicles interacting with pedestrians (stopping, slowing, swerving etc.), and drivers of vehicles responding to light conditions of the traffic light 115 (running a red light, speeding up at a yellow light, etc.). The data collected by the IoT module 116 can be transmitted in real-time or after a delay period, to devices such as the server computer 150, the onboard computer 112 of the autonomous vehicle 110, and/or the cloud storage 130.

The personal device 126 carried by the pedestrian 125 can also share some types of data with the server computer 150, the onboard computer 107 of the autonomous vehicle 105, the onboard computer 112 of the autonomous vehicle 110, and/or the cloud storage 130. For example, the personal device 126 may provide data in the form of location information of the pedestrian 125 at various times (standing at a location in the sidewalk over a first period of time, starting to cross the road 120 at a location and at a second instant in time, walking on the sidewalk over a third period of time, etc.), behaviors of the pedestrian 125 (texting while walking, engaging in phone calls while crossing the road 120, using the personal device 126 to hail a cab or ride service, etc.), and interaction with vehicles (getting into a taxi at a first location on the road 120 that is near a pedestrian crosswalk, getting into a taxi stopped in a pedestrian crosswalk, etc.).

The cloud storage 130 may be used to store various types of data obtained from various sources such as, for example, the onboard computer 107, the onboard computer 112, the server computer 150, the social media computer 155, and the IoT module 116. The cloud storage 130 may also be used to store data from other sources such as from one or more computers operated by entities such as a civic authority (county, city, or state), a state agency, a federal agency, a standards organization, and/or a police authority.

Data provided by the social media computer 155 for storage in the cloud storage 130 can include various items such as complaints, feedback, and comments received from members of the public pertaining to the road 120. For example, a first member of the public may post a complaint on the social media computer 155 about a road hazard present at a particular location on the road 120, another member of the public may upload into the social media computer 155, images of an event that took place on the road 120 that led to a traffic accident, and yet another member of the public may share on the social media computer 155 information about a traffic light condition on the road 120. Such data may be generally referred to herein as social media data.

Data provided by computers operated by civic authorities and government agencies may pertain to repairs, modifications, and installations performed upon the road 120, complaints received from the public about the road 120, police reports (accident reports, citations, violations, etc.) associated with users of the road 120, and road infrastructure data (construction details, dimensions, and/or specifications about a bridge or an overpass, for example).

The server computer 150 may be configured to receive data from various sources such as the onboard computer 107 of the autonomous vehicle 105, the onboard computer 112 of the autonomous vehicle 110, the IoT module 116, the personal device 126, the social media computer 155, and/or the cloud storage 130, and to execute various operations upon the received data in accordance with various embodiments of the disclosure. The various operations can include executing data analytics upon the data for identifying various types of behaviors, patterns, and risk factors associated with road safety measures applicable to the road 120, and can also include prescriptive measures for addressing, remedying, and/or implementing road safety measures.

In an exemplary implementation in accordance with the disclosure, the server computer 150 receives sensor data from onboard computers of one or more autonomous vehicles. The sensor data, which may be obtained by various sensors (such as, for example, an imaging device in the navigation assistance equipment 106 and/or an imaging device in the navigation assistance equipment 111), may be analyzed by the server computer 150 to derive information such as, for example, vehicular behavior characteristics and pedestrian behavioral characteristics. The information may be used by the server computer 150 to identify one or more risk factors associated with road safety (such as a risk factor in connection with pedestrian injuries on a crosswalk of the road 120). The information may be presented by the server computer 150 to a human operator in various forms such as in the form of road safety data overlaid upon a map, a graphical rendering, and/or as text (a message, for example). The human operator may use the map, graphical rendering, or text to identify one or more locations on the road 120 that are susceptible to traffic accidents. Prescriptive road traffic measures may then be taken to mitigate or eliminate some or all of the risk factors.

In another exemplary implementation in accordance with the disclosure, the server computer 150 may receive connected vehicle data from one or more sources such as the onboard computer 107, the onboard computer 112, and the IoT module 116, and analyze the connected vehicle data for identifying risk factors associated with road safety.

In yet another exemplary implementation, the server computer 150 may receive various types of social media data and road infrastructure data from one or more sources such as the cloud storage 130 and the social media computer 155. The social media data and road infrastructure data may be analyzed by the server computer 150 for identifying risk factors associated with road safety.

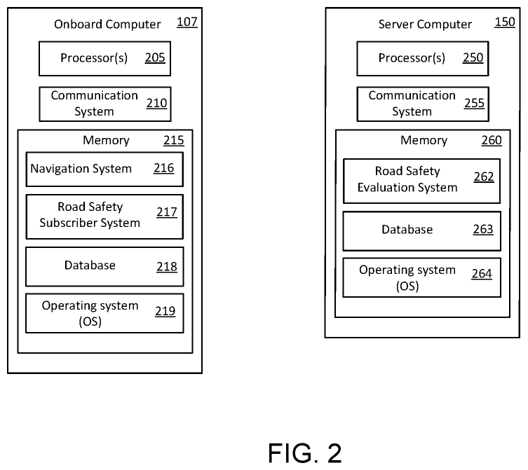

FIG. 2 shows some exemplary components that may be included in the onboard computer 107 of the autonomous vehicle 105 and in the server computer 150. The onboard computer 107 of the autonomous vehicle 105 may include a processor 205, a communication system 210, and a memory 215. The communication system 210 can include a wireless transceiver that allows the onboard computer 107 to transmit and/or receive various types of data from the navigation assistance equipment 106 and various elements of the system 100 such as, for example, the server computer 150, the onboard computer 112 of the autonomous vehicle 110, the IoT module 116 mounted on the traffic light 115, the personal device 126 carried by the pedestrian 125, the social media computer 155, and one or more storage units of the cloud storage 130.

The memory 215, which is one example of a non-transitory computer-readable medium, may be used to store an operating system (OS) 219, a database 218, and various code modules such as a navigation system 216 and a road safety subscriber system 217. The code modules are provided in the form of computer-executable instructions that can be executed by the processor 205 for performing various operations in accordance with the disclosure.

The navigation system 216 may include code that allows the onboard computer 107 to interact with various hardware components of the autonomous vehicle 105 for driving and navigating the autonomous vehicle 105. The hardware components may include the navigation assistance equipment 106 and other items such as a steering mechanism, an ignition switch, an accelerator, a braking mechanism, a door lock mechanism, and a Global Positioning System (GPS) system.

The road safety subscriber system 217 of the onboard computer 107 may include computer-executable instructions that are executable by the processor 205 to configure the communication system 210 to receive data from various sources, such as sensor data from the navigation assistance equipment 106, connected vehicle data from the onboard computer 112 of the autonomous vehicle 110, and data from the IoT module 116. The received data may be stored in the database 218.

The road safety subscriber system 217 of the onboard computer 107 may further include computer-executable instructions that are executable by the processor 205 to configure the communication system 210 to transmit the data stored in the database 218 to the server computer 150. The server computer 150 may use the data (sensor data, connected vehicle data, data from the IoT module 116, etc.) Independently and/or by combining with data received from other sources for performing various operations associated with road safety measures in accordance with the disclosure.

The server computer 150, which is communicatively coupled to the onboard computer 107 of the autonomous vehicle 105 via the network 140, may include a processor 250, a communication system 255, and a memory 260. The communication system 255 can include a wireless transceiver that allows the server computer 150 to transmit and/or receive various types of data from various sources such as the onboard computer 107 of the autonomous vehicle 105, the onboard computer 112 of the autonomous vehicle 110, the IoT module 116 mounted on the traffic light 115, the personal device 126 carried by the pedestrian 125, the social media computer 155, and one or more storage units of the cloud storage 130.

The memory 260, which is another example of a non-transitory computer-readable medium, may be used to store an operating system (OS) 264, a database 263, and various code modules such as a road safety evaluation system 262. The code modules are provided in the form of computer-executable instructions that can be executed by the processor 250 for performing various operations in accordance with the disclosure.

The road safety evaluation system 262 may include computer-executable instructions that are executable by the processor 250 to configure the communication system 255 to receive data from various sources, such as sensor data from the onboard computer 107 of the autonomous vehicle 105, navigation assistance equipment 106, sensor data from the onboard computer 112 of the autonomous vehicle 110, connected vehicle data from the onboard computer 107 of the autonomous vehicle 105, connected vehicle data from the onboard computer 112 of the autonomous vehicle 110, data from the IoT module 116, data from the personal device 126 of the pedestrian 125, social media data from the social media computer 155, and road infrastructure data and other data from the cloud storage 130. Such data may be referred to herein, as holistic data.

The received data may be stored in the database 263. The road safety evaluation system 262 may further include computer-executable instructions that are executable by the processor 250 to analyze some or all of the received data and determine various risk factors associated with the road 120. For example, the road safety evaluation system 262 may be used to analyze data received from the IoT module 116 to determine some types of human behaviors. Human behaviors may include the manner in which the pedestrian 125 moves, such as, for example, running across the road 120 when the traffic light 115 is in a red condition, crossing the road 120 at a place other than a crosswalk, stepping off the sidewalk when the traffic light 115 shows a warning not to cross, etc. These human behaviors may introduce certain risk factors that may be identified and addressed by using the road safety evaluation system 262. For example, a speed bump may be installed in a section of the road 120 and/or an additional traffic light installed. Installation of the speed bump and/or the traffic light are two examples of pre-emptive actions that may be taken prior to the occurrence of accidents.

Pre-emptive actions may also be taken in view of vehicular behaviors that may be identified by using the road safety evaluation system 262 to analyze connected vehicle data. The connected vehicle data provides an indication of how vehicles such as the autonomous vehicle 105 and the autonomous vehicle 110 behave when driving on the road 120. For example, the vehicular behavior of the autonomous vehicle 105 and/or the autonomous vehicle 110 may provide information indicating that autonomous vehicles fail to provide enough clearance with respect to pedestrians such as the pedestrian 125, when the pedestrian 125 has stepped off the sidewalk and is standing on the road 120. In response to obtaining this information, the onboard computer 107 and/or the onboard computer 112 may be reprogrammed to provide the appropriate clearance prior to the occurrence of a mishap on the road 120.

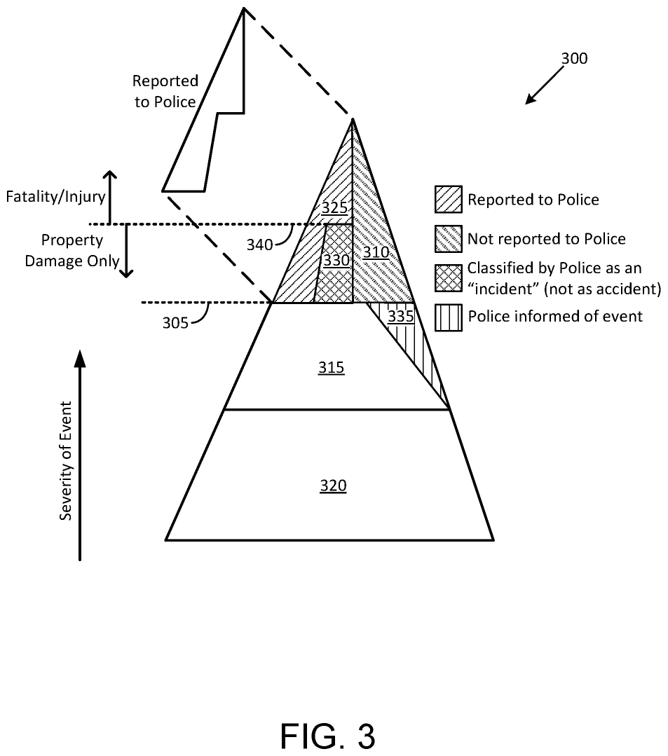

FIG. 3 shows an exemplary representation 300 of various sources of data that may be used to implement road safety measures in accordance with the disclosure. The representation 300 has a pyramid configuration with severity of traffic events increasing from a base of the pyramid to a peak of the pyramid. A lowermost section 320 of the pyramid represents traffic events where traffic accidents (such as crashes and collisions) were avoided. The section 320 can include, for example, instances where the autonomous vehicle 105 swerved or braked so as avoid coming in contact with the pedestrian 125 stepping off the sidewalk and on to the road 120 at a spot other than a crosswalk.

A section 315 represents traffic events of a minor nature that were not reported to the police. The section 315 may include, for example, a situation where the pedestrian 125 jaywalked on the road 120 but was not reported to the police.

A section 335 represents traffic events of a minor nature where the police were called and the police considered these events as incidents and not accidents. The section 335 may include, for example, an incident where the police were called to report the pedestrian 125 jaywalking on the road 120 and the police let the pedestrian 125 go with a written warning.

A dashed line 305 indicates a threshold above which any traffic event is deemed reportable. Accordingly, a section 325 that is above the dashed line 305 represents traffic events that were reported to the police and recognized by the police as accidents. Another section 330 that is also above the dashed line 305 represents traffic events that were reportable but were not reported because the traffic events occurred in areas that were not located on a public road. The traffic events indicated by section 330 may have been, at best, reported to the police as an incident rather than as a traffic accident. Yet another section 310 that is above the dashed line 305 represents traffic events that were not reported to the police.

A dashed line 340 indicates a threshold below traffic events led to property damage but no fatalities or injuries occurred. Traffic events above the dashed line 340 involved fatalities and/or injuries.

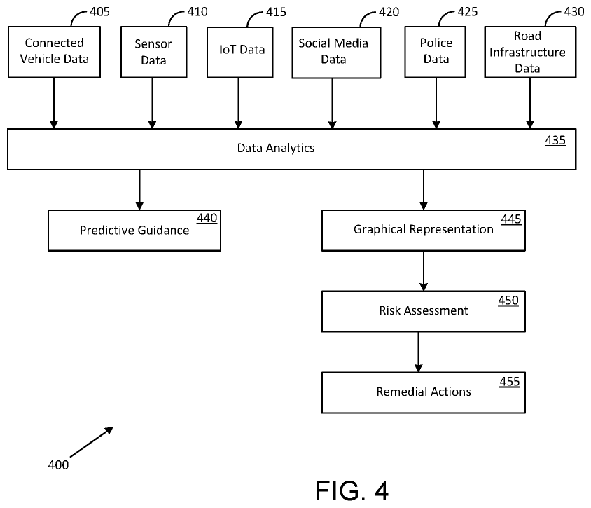

FIG. 4 shows an exemplary flowchart 400 of a method for using holistic data to implement road safety measures in accordance with the disclosure. The flowchart 400 illustrates a sequence of operations that can be implemented in hardware, software, or a combination thereof. In the context of software, the operations represent computer-executable instructions stored on one or more non-transitory computer-readable media such as the memory 215 and the memory 260, that, when executed by one or more processors such as the processor 205 and the processor 250 respectively, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 400 may be carried out by using an application such as the road safety subscriber system 217 in the memory 215 of the onboard computer 107 in the autonomous vehicle 105 and/or the road safety evaluation system 262 in the memory 260 of the server computer 150. The description below may make reference to certain vehicles and structures such as the autonomous vehicle 105 and the road 120, but it should be understood that this is done for purposes of explaining certain aspects of the disclosure and that the description is equally applicable to many other vehicles and structures.

In an exemplary method represented by the flowchart 400, the server computer 150 may use the communication system 255 to communicate with various sources for receiving holistic data. A few examples of holistic data that may be received by the server computer 150 can include connected vehicle data 405, sensor data 410, IoT data 415, social media data 420, police data 425, and road infrastructure data 430. The connected vehicle data 405 may be received from the onboard computer 107 of the autonomous vehicle 105 and/or the onboard computer 112 of the autonomous vehicle 110. The sensor data 410 may be received from the navigation assistance equipment 106 of the autonomous vehicle 105 (by using the communication system 210 in the onboard computer 107) and/or the navigation assistance equipment 111 of the autonomous vehicle 110 (by using the communication system 255 in the onboard computer 112). The IoT data 415 may be received from various sources such as the IoT module 116, the onboard computer 107, and/or the onboard computer 112.

The social media data 420 may be received from the social media computer 155. The police data 425 (such as reported accident data) may be received from the cloud storage 130 and/or from other sources such as a police computer system. The police-reported accident data may correspond to section 325 in the representation 300 shown in FIG. 3. The road infrastructure data 430 may be received from the cloud storage 130 and/or other elements such as a computer system operated by a government authority (for example, city government or state government). Road infrastructure data may provide information such as specifications about a bridge or an overpass, repairs or modifications being carried out on sections of the road 120, and/or repairs or modifications planned for the road 120.

At block 435, the server computer 150 may use analytical procedures (one or more algorithms, for example) to analyze some or all of the received holistic data. The analytical procedures may be directed, for example, at characterizing human behaviors and vehicle behaviors with respect to the road 120 and/or for identifying one or more risk factors associated with the road 120. An exemplary risk factor may indicate a probability of an injury or fatality as a result of a behavior of the pedestrian 125 and/or other people near the traffic light 115. The risk factor may be identified by analyzing the IoT data 415 for example. Another exemplary risk factor associated with a road hazard may be based on analyzing social media data 420. Yet another exemplary risk factor that may make a location more susceptible to a traffic accident may be identified by combining information gained by combining two or more data sources such as, for example, combining the social media data 420 with police data 425.

At block 440, predictive guidance may be provided based on information derived by analyzing some or all of the received holistic data. For example, information may be derived by executing one or more simulation procedures upon some or all of the holistic data to simulate various potential situations, conditions, and scenarios. The predictive guidance can include recommendations for actions that may be taken to reduce, or to prevent, certain types of traffic accidents. For example, the predictive guidance may provide an indication that the amount of traffic on road 120 may double if certain changes are made to one or more feeder roads that lead into the road 120. The changes to the feeder roads may then be modified or cancelled in view of this predictive guidance.

At block 445, the results of the data analytics may be provided to a human operator in various formats. One exemplary format features road safety data overlaid upon a map or a graphical rendering. The human operator may use the map or graphical rendering to identify one or more locations on the road 120 that are susceptible to traffic accidents.

At block 450, the server computer 150 and/or a human operator can carry out a risk assessment to determine if the risk factors identified by the data analytics meets certain criteria (for example, exceeds a threshold level, or is highly desired by the public).

At block 455, remedial action may be taken based on the risk assessment indicated in block 450. An exemplary remedial action may involve providing of a speed bump on the road 120 or modifying an operational light sequence of the traffic light 115.

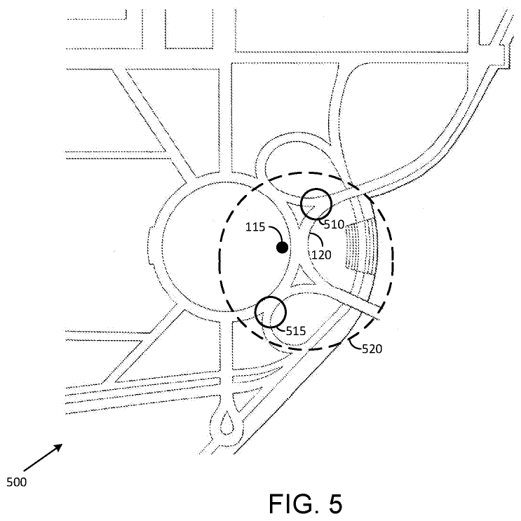

FIG. 5 shows an exemplary graphical representation 500 that may be provided by the server computer 150 based on information gained by analyzing holistic data in accordance with the disclosure. The graphical representation 500 includes a map of an area in which the road 120 is located. A human operator viewing the graphical representation 500 may desire to obtain information about risk factors that may be present inside an area 520 identified by the human operator (by using a stylus or a mouse, for example). The server computer 150 may respond by displaying a first icon at a first location inside the area 520 that is highly susceptible to traffic accidents and a second icon at a second location inside the area 520 that is moderately susceptible to traffic accidents.

In one exemplary implementation, the first icon may be a red circle 510 and the second icon may be an orange colored circle 515, the colors indicative of the level of risk. Additional details about the risk factors associated with the two locations may be obtained by clicking on any of the displayed icons. For example, clicking on the red circle 510, may provide additional information associated with the first location such as, for example, factors that contribute to the risk factor (for example, high average vehicular speeds as determined from connected vehicle data), police data (number of speeding tickets issued at the first location), and/or pedestrian behavior (IoT data that shows most pedestrians do not use a crosswalk near the traffic light 115). Remedial action may be taken to address such risk factors.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 215 and the memory 260, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by at least a first computer, a first dataset comprising sensor data obtained by one or more sensors in a first vehicle;
analyzing, by the first computer, at least the sensor data in the first dataset to identify one or more risk factors associated with one or more roads; and
providing, by the first computer and based at least in part on identifying the one or more risk factors, an indication of one or more locations susceptible to traffic accidents.

2. The method of claim 1 wherein providing, by the first computer, the indication of one or more locations susceptible to traffic accidents comprises:
generating, by the first computer, at least one of a map, a graphical representation, or a text that identifies the one or more locations on the one or more roads.

3. The method of claim 1, wherein the first vehicle is an autonomous vehicle and wherein the sensor data provides information associated with at least one of a traffic accident that was averted by the autonomous vehicle or a traffic hazard encountered by the autonomous vehicle.

4. The method of claim 3, wherein the sensor data comprises at least one of an image, a video recording, or an audio recording that provides information associated with the at least one of the traffic accident or the traffic hazard.

5. The method of claim 1, wherein the first dataset further comprises one or more of connected vehicle data, social media data, human behavioral data, and road infrastructure data.

6. The method of claim 5, wherein the connected vehicle data comprises machine-to-machine communications between the first vehicle and at least a second vehicle.

7. The method of claim 5, wherein the social media data comprises content posted online about at least one of events or conditions that are indicative of risk factors for users of the one or more roads.

8. The method of claim 5, wherein the human behavioral data provides an indication of at least one of behaviors of drivers on the one or more roads or behaviors of pedestrians on the one or more roads.

9. A method comprising:
receiving, by a first computer, at least a first dataset comprising connected vehicle data obtained by an onboard computer provided in a first vehicle;
analyzing, by the first computer, at least the connected vehicle data in the first dataset for identifying one or more risk factors associated with one or more roads; and
providing, by the first computer and based at least in part on the one or more risk factors, an indication of one or more locations that are susceptible to traffic accidents.

10. The method of claim 9, wherein the connected vehicle data includes machine-to-machine communications between the onboard computer provided in the first vehicle and a third computer that is one of: a second vehicle, is a part of an apparatus mounted on a roadside fixture, or is a part of an apparatus located inside a building.

11. The method of claim 10, wherein the apparatus mounted on the roadside fixture comprises an Internet-of-Things (IoT) device.

12. The method of claim 9, wherein the first dataset further comprises sensor data obtained by one or more sensors provided in the first vehicle, the sensor data providing information associated with at least one of a traffic accident that was averted by the first vehicle or a traffic hazard encountered by the first vehicle when driving on the one or more roads.

13. The method of claim 9, wherein the first dataset further comprises one or more of social media data, human behavioral data, and road infrastructure data, the social media data comprising content posted online about at least one of events or conditions that are indicative of risk factors for users of the one or more roads, the human behavioral data providing an indication of at least one of behaviors of drivers on the one or more roads or behaviors of pedestrians on the one or more roads, the road infrastructure data comprising information on one or more structures that contribute to risk factors for users of the one or more roads.

14. The method of claim 9, further comprising:
receiving, in the first computer, from an onboard computer provided in a second vehicle, a second dataset comprising connected vehicle data; and
analyzing, by the first computer, the connected vehicle data in the first dataset and the connected vehicle data in the second dataset to identify the one or more risk factors associated with the one or more roads.

15. A system comprising:
a first computer that includes:
at least one memory that stores computer-executable instructions; and
at least one processor configured to access the at least one memory and execute the computer-executable instructions to at least:
receive a first dataset comprising at least one of connected vehicle data obtained by an onboard computer provided in a first vehicle or sensor data obtained by one or more sensors provided in the first vehicle;
analyze at least one of the connected vehicle data or the sensor data to identify one or more risk factors associated with one or more roads; and
provide, based at least in part on the one or more risk factors, an indication of one or more locations that are susceptible to traffic accidents.

16. The system of claim 15, further comprising:
a second computer that is one of: located in a second vehicle, is a part of an apparatus mounted on a roadside fixture, or is a part of an apparatus located inside a building, and wherein the onboard computer provided in the first vehicle is configured to obtain the connected vehicle data based on machine-to-machine communications with the second computer.

17. The system of claim 16, wherein the apparatus mounted on the roadside fixture comprises an Internet-of-Things (IoT) device.

18. The system of claim 15, wherein the sensor data comprises at least one of an image, a video recording, or an audio recording, that provides information associated with at least one of a traffic accident that was averted by the first vehicle or a traffic hazard encountered by the first vehicle.

19. The system of claim 15, wherein the first dataset further comprises one or more of social media data, human behavioral data, and road infrastructure data.

20. The system of claim 19, wherein the social media data comprises content posted online about at least one of events or conditions that are indicative of risk factors for users of the one or more roads, the human behavioral data provides an indication of at least one of behaviors of drivers on the one or more roads or behaviors of pedestrians on the one or more roads, and the road infrastructure data comprises information on one or more structures that contribute to risk factors for users of the one or more roads.
